(19) United States
(12) Patent Application Publication
(10) Pub. No.: US 2009/0324973 A1
(43) Pub. Date: Dec. 31, 2009

(54) MAGNETIC RECORDING MEDIUM AND MAGNETIC RECORDING APPARATUS

(75) Inventor: Jun Taguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/418,284

(22) Filed: Apr. 3, 2009

(30) Foreign Application Priority Data
Jun. 27, 2008 (JP) 2008-168500

(51) Int. Cl. B32B 15/00

(52) U.S. Cl. 428/457

(57) ABSTRACT

A magnetic recording medium includes a substrate and a layer stack unit that has n (n being 3 or an integer greater than 3) magnetic recording layers, and (n−1) exchange coupling control layers placed in respective spaces between the n magnetic recording layers, the n magnetic recording layers and the (n−1) exchange coupling control layers being stacked on the substrate.

### CROSS-REFERENCE TO RELATED APPLICATION

This application is based upon and claims the benefit of priority of the prior Japanese Patent Application No. 2008-168500, filed on Jun. 27, 2008, the entire contents of which are incorporated herein by reference.

### FIELD

The present invention generally relates to a magnetic recording medium and a magnetic recording apparatus.

### BACKGROUND

In recent years, magnetic recording media for perpendicular magnetic recording (perpendicular magnetic recording media) have been developed so as to realize high-density recording on magnetic recording media such as hard disks. To achieve higher density in such perpendicular magnetic recording media, the recording inverted magnetic field of each magnetic recording medium is being reduced. One of the techniques for reducing the recording inverted magnetic field is an ECC (Exchange Coupled Composite) medium technique (see Japanese Unexamined Patent Publication No. 2006-209943, for example).

According to the ECC medium technique, an exchange coupling control layer made of a nonmagnetic metal is interposed between a high-Hk (anisotropic magnetic field) magnetic recording layer and a low-Hk magnetic recording layer, so as to control the coupling force between the magnetic recording layers. In this manner, the recording inverted magnetic field of the medium is reduced.

An ECC medium conventionally has the stack structure depicted in FIG. 6. The ECC medium depicted in FIG. 6 includes a substrate 20a and a stack layer portion 120 that includes a high-Hk first magnetic recording layer 20d, an exchange coupling control layer 20e, a second magnetic recording layer 20f, and a third magnetic recording layer 20g that are stacked on the substrate 20a. Among those layers, a granular material is being considered as a material for the first magnetic recording layer 20d and the second magnetic recording layer 20f, and a non-granular material is being considered as a material for the third magnetic recording layer 20g.

To reduce the recording inverted magnetic field in such an ECC medium, it is necessary to increase the thickness of the exchange coupling control layer. However, if the exchange coupling control layer is made thicker, the coupling force between the magnetic recording layers (the first and second magnetic recording layers 20d and 20f) sandwiching the exchange coupling control layer might become smaller. If the coupling force between the magnetic recording layers becomes smaller, the variation (ΔHs) of the recording inverted magnetic field becomes greater, and the S-N properties deteriorate. As a result, the magnetic recording properties and reproduction resolution performance might become poorer.

### SUMMARY

According to an aspect of the present invention, there is provided a less-expensive SAW device having a reduced size including a reduced height.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view of a magnetic recording apparatus in accordance with an embodiment of the present invention;

FIG. 2 depicts the structure of the magnetic disk depicted in FIG. 1;

FIG. 3 depicts an example of the hysteresis loop of an ECC medium;

FIGS. 4A through 4C depict various static magnetic properties, relative to the layer thicknesses of exchange coupling control layers;

FIG. 5 depicts the S-N properties; and

FIG. 6 depicts an example of a conventional ECC medium.

### DESCRIPTION OF EMBODIMENTS

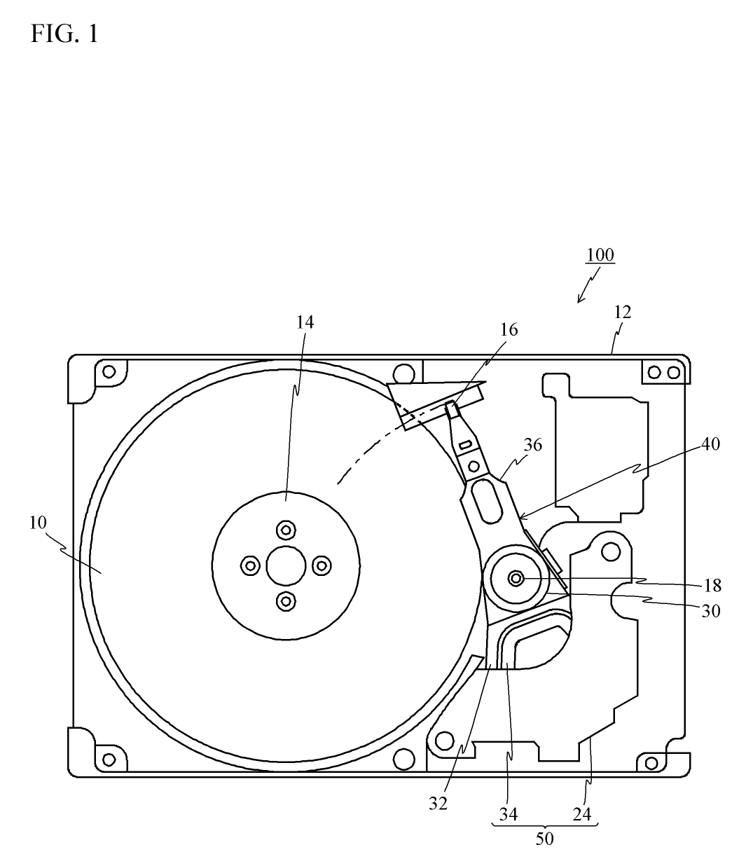

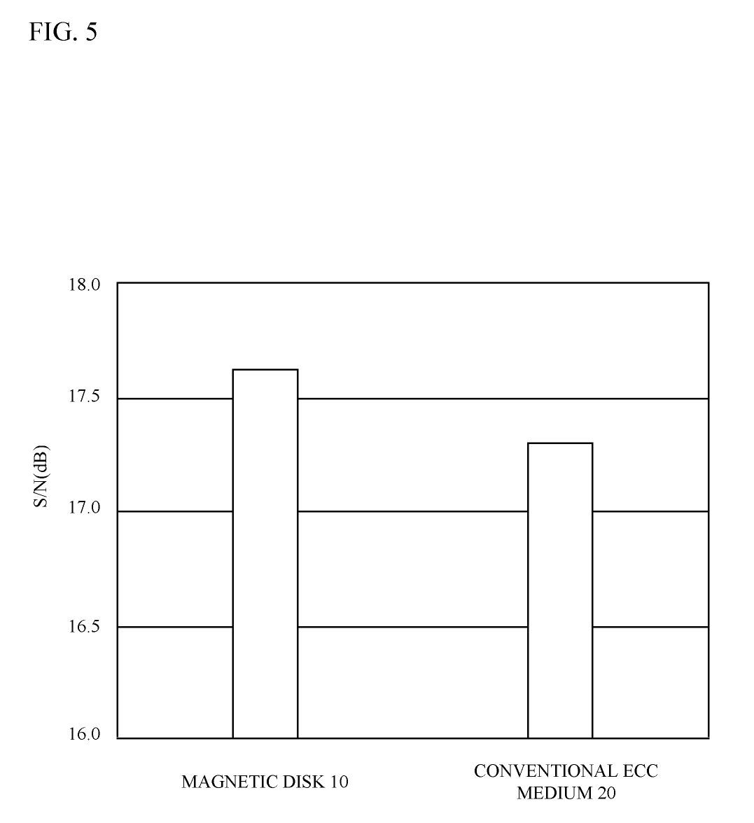

The following is a description of an embodiment of a magnetic recording medium and a magnetic recording apparatus in accordance with the present invention, with reference to FIGS. 1 through 6.

FIG. 1 depicts the inner structure of a hard disk drive (HDD) 100 as a magnetic recording apparatus in accordance with the embodiment. As depicted in FIG. 1, the HDD 100 includes a box-like housing 12, a magnetic disk 10 as a magnetic recording medium housed in a space (an accommodating space) of the housing 12, a spindle motor 14, and a head stack assembly (HSA) 40. The housing 12 is formed with a base and a top cover in reality, but only the base is depicted in FIG. 1 for convenience sake.

The magnetic disk 10 has its upper surface as a recording face, and is rotated about its rotational axis at a high speed of 4200 to 15000 rpm by the spindle motor 14. Both the upper surface and the lower surface of the magnetic disk 10 may serve as recording faces. Also, more than one magnetic disk 10 may be provided in a direction perpendicular to the plane of the paper sheet of FIG. 1.

The HSA 40 includes a cylindrical housing portion 30, a fork portion 32 fixed to the housing portion 30, a coil 34 held by the fork portion 32, a carriage arm 36 fixed to the housing portion 30, and a head slider 16 held by the carriage arm 36. In a case where both the upper surface and the lower surface of the magnetic disk 10 are recording faces, as described above, two carriage arms and two head sliders are provided in a vertically symmetrical manner, so that the magnetic disk 10 is interposed between the two sets of carriage arms and head sliders. In a case where two or more magnetic disks are provided, carriage arms and head sliders are provided for the respective recording faces of the magnetic disks.

The carriage arm 36 is formed by stamping it out of a stainless plate or performing extrusion processing on an aluminum material. The head slider 16 has a recording reproduction head (hereinafter referred to simply as the “head”) including a recording device and a reproducing device.

The HSA 40 is rotatably (being rotatable about the Z-axis) connected to the housing 12 via a bearing member 18 provided at the center of the housing portion 30. A voice coil motor 50 that is formed with the coil 34 of the HSA 40 and a magnetic pole unit 24 including a permanent magnet fixed to the base of the housing 12 causes the HSA 40 to rotationally move about the bearing member 18. In FIG. 1, the trajectory of the rotational movement is represented by the dot-and-dash line.

In the HDD 100 having the above structure, data (information) reading and writing are performed on the magnetic disk 10 by the recording reproduction head provided at the top end of the carriage arm 36. In this case, the head slider 16 holding the recording reproduction head is lifted up from the upper surface of the magnetic disk 10 by the lifting power generated by the rotations of the magnetic disk 10. The recording reproduction head performs data reading and writing, while maintaining a very short distance from the magnetic disk 10. As the carriage arm 36 rotationally moves as described above, the recording reproduction head moves and seeks through the magnetic disk 10 in the transverse direction of the tracks, and changes the tracks on which reading or writing is to be performed.

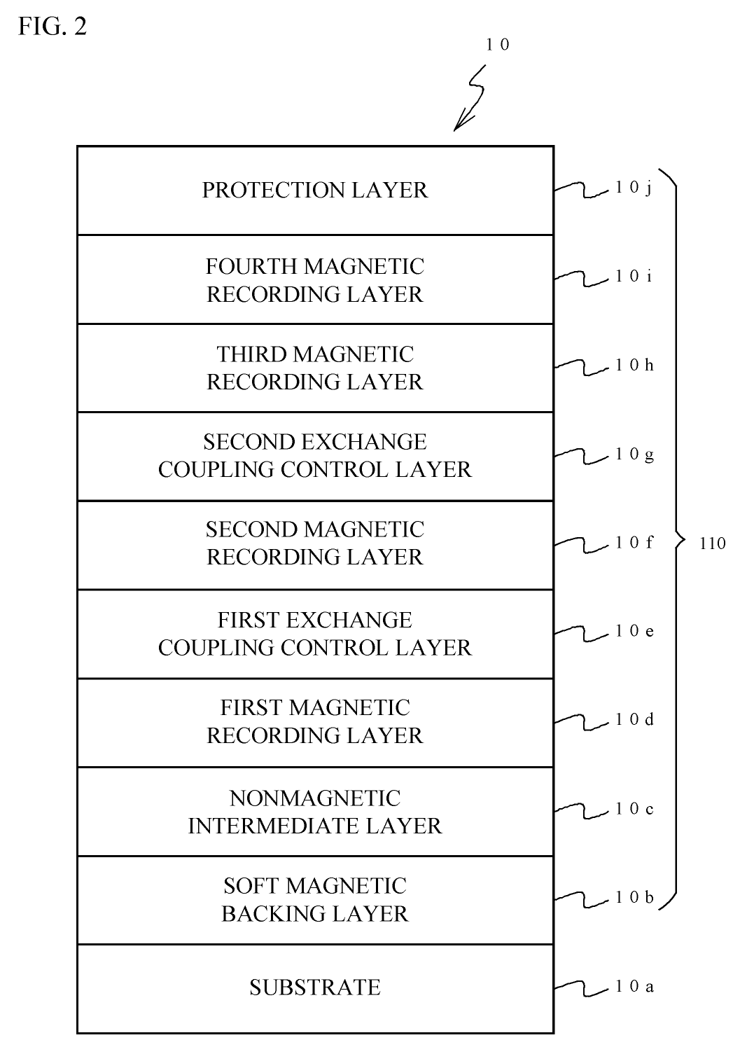

Referring now to FIG. 2, the structure of the magnetic disk 10 of this embodiment is described in detail.

FIG. 2 schematically depicts the stack structure of the magnetic disk 10. As depicted in FIG. 2, the magnetic disk 10 includes a substrate 10a and a layer stack portion 110 formed with layers stacked one by one.

The substrate 10a may be a plastic substrate, a crystallized glass substrate, a hardened glass substrate, a Si substrate, an aluminum alloy substrate, or the like.

The layer stack portion 110 includes a soft magnetic backing layer 10b, a nonmagnetic intermediate layer 10c, a first magnetic recording layer 10d, a first exchange coupling control layer 10e, a second magnetic recording layer 10f, a second exchange coupling control layer 10g, a third magnetic recording layer 10h, a fourth magnetic recording layer 10i, and a protection layer 10j.

The soft magnetic backing layer 10b may be made of an amorphous or microcrystalline soft magnetic material that contains at least one element selected from the group consisting of Fe, Co, Ni, Al, Si, Ta, Ti, Zr, Hf, V, Nb, C, and B, for example. In this embodiment, the soft magnetic backing layer 10b is made of a highly-permeable amorphous FeCo alloy

The nonmagnetic intermediate layer 10c may be made of Ru, Rh, Ir, a Ru-based alloy, an Rh-based alloy, an Ir-based alloy, or the like. Among those materials, the Ru-based alloy, the Rh-based alloy, and the Ir-based alloy each have an additional element selected from the group consisting of Co, Cr, Fe, Ni, and Mn, or an alloy containing any of those materials. In this embodiment, the nonmagnetic intermediate layer 10c is made of Ru. Being capable of facilitating the plane-perpendicular orientation of the magnetization easy axis, Ru exhibits excellent lattice matching properties with magnetic recording layers.

The first magnetic recording layer 10d, the second magnetic recording layer 10f, and the third magnetic recording layer 10h may be made of a granular material formed with a CoCrPt alloy or the like and an oxide. The fourth magnetic recording layer 10i may be made of an alloy material containing CoCrPt or the like.

In this embodiment, the first magnetic recording layer 10d is made of a granular material having TiO₂ added to a CoCrPt alloy, and its Pt composition amount is 20 atomic %. With the use of such a material, the anisotropic magnetic field of the first magnetic recording layer 10d can be set high. Also, it is possible to maintain the excellent lattice matching properties with the nonmagnetic intermediate layer.

The second magnetic recording layer 10f and the third magnetic recording layer 10h are made of a granular material having TiO₂ added to a CoCrPt alloy, and its Pt composition amount is 15 atomic %. With the use of such a material, the anisotropic magnetic field of the second and third magnetic recording layers 10f and 10h can be set lower than the anisotropic magnetic field of the first magnetic recording layer 10d.

The fourth magnetic recording layer 10i is made of a CoCrPtB material having B added to a CoCrPt alloy. By adding B to a CoCrPt alloy, a crystal grain refining effect and a Cr segregating effect are expected.

The first exchange coupling control layer 10e and the second exchange coupling control layer 10g are made of a nonmagnetic metal. The first exchange coupling control layer 10e and the second exchange coupling control layer 10g control the coupling force between each two magnetic recording layers located above and below the exchange coupling control layers, so as to reduce the recording inversion magnetic field. The first exchange coupling control layer 10e and the second exchange coupling control layer 10g may be made of Ru, Rh, Ir, a Ru-based alloy, a Rh-based alloy, an Ir-based alloy, Cu, Cr, or the like. Among those materials, the Ru-based alloy, the Rh-based alloy, and the Ir-based alloy each have an additional element selected from the group consisting of Co, Cr, Fe, Ni, and Mn, or an alloy containing any of those materials. In this embodiment, the first and second exchange coupling control layers 10e and 10g are made of Ru or a Ru-based alloy. Since the lattice constant of Ru or a Ru-based alloy is substantially the same as the lattice constant of a CoCrPt-based alloy, excellent lattice matching properties can be achieved.

The protection layer 10j is made of amorphous carbon, carbon hydride, carbon nitride, aluminum oxide, or the like. A lubricant layer may be further provided on the protection layer 10j. As the lubricant layer, it is possible to use a lubricant agent containing perfluoropolyether as the main chain, for example.

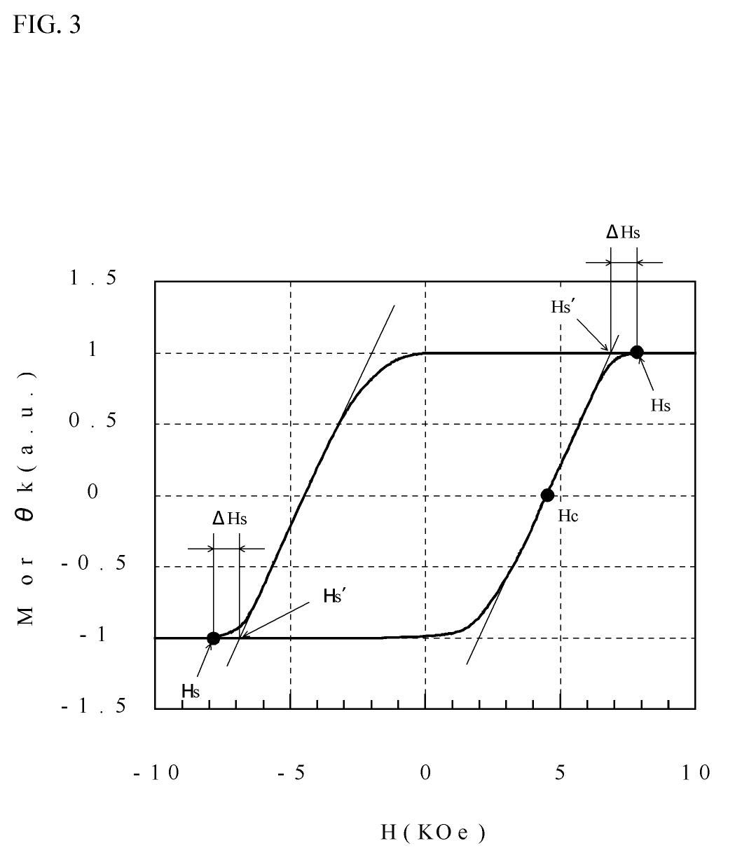

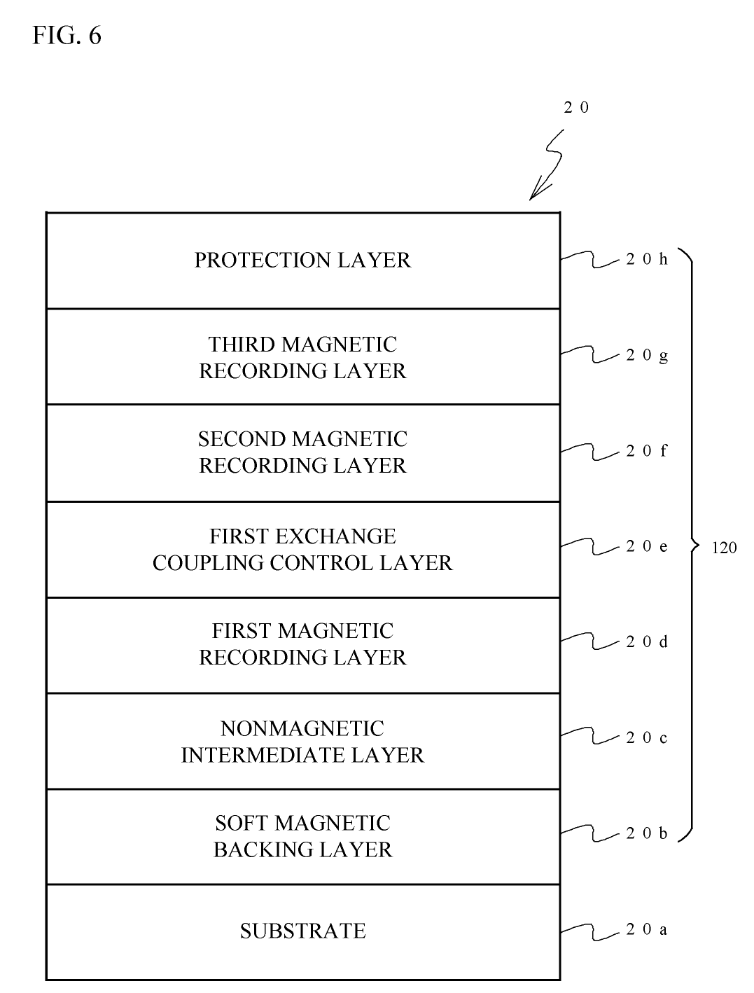

Referring now to FIGS. 3 through 5, the reason that the two exchange coupling control layers 10e and 10g are used in this embodiment is described, and the conventional ECC medium (a medium having one exchange coupling control layer) 20 depicted in FIG. 6 is also described as a comparative example.

The materials of the layers of the ECC medium 20 being described here as a comparative example are the same as the materials used in the magnetic disk 10. More specifically, in the structure depicted in FIG. 6, glass is used as the material of the substrate 20a, a FeCo alloy is used as the material of the soft magnetic backing layer 20b, and Ru is used as the material of the nonmagnetic intermediate layer 20c. A granular material having TiO₂ added to a CoCrPt alloy (the Pt composition amount being 20 atomic %) is used as the material of the first magnetic recording layer 20d, and a granular material having TiO₂ added to a CoCrPt alloy (the Pt composition amount being 15 atomic %) is used as the material of the second magnetic recording layer 20f. Further, a CoCrPtB material having B added to a CoCrPt alloy (the Pt composition amount being 15 atomic %) is used as the material of the third magnetic recording layer 20g, and Ru is used as the material of the exchange coupling control layer 20e.

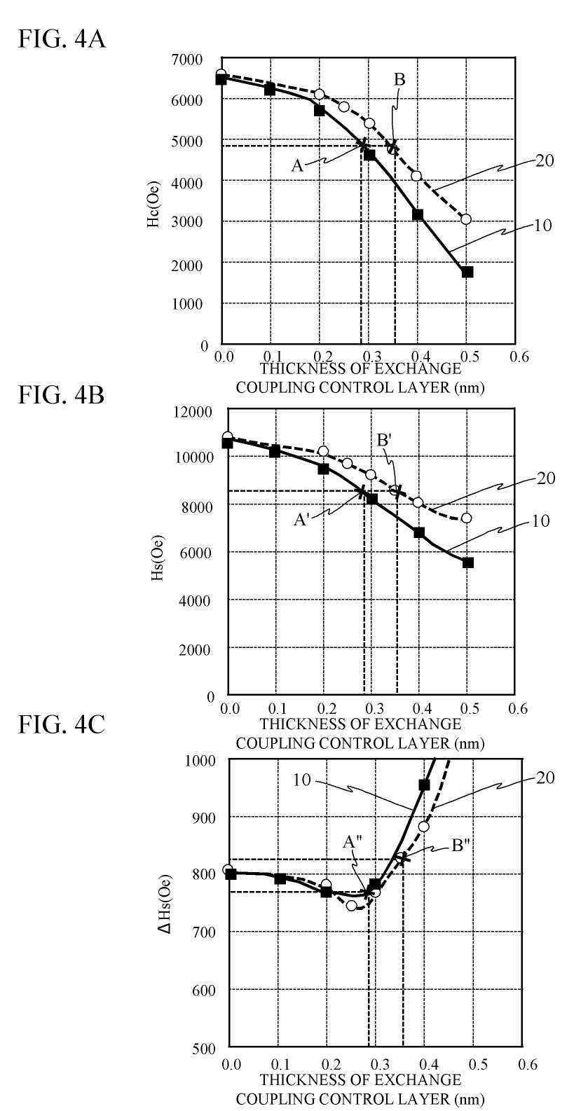

FIGS. 4A through 4C are graphs depicting the magnetic properties of the magnetic disks, relative to the layer thicknesses of the respective exchange coupling control layers. FIG. 4A depicts the relationship between the layer thickness of each exchange coupling control layer and the coercive force Hc. FIG. 4B depicts the relationship between the layer thickness of each exchange coupling control layer and the recording inverted magnetic field Hs. FIG. 4C depicts the relationship between the layer thickness of each exchange coupling control layer and the parameter ΔHs representing the variation of the recording inverted magnetic field.

The coercive force Hc, the recording inverted magnetic field Hs, and the parameter ΔHs representing the variation of the recording inverted magnetic field in this case appear in the hysteresis loop (that can be measured with a Kerr-effect micro-measuring device) of each ECC medium as depicted in FIG. 3. As can be seen from FIG. 3, ΔHs represents the difference between the recording inverted magnetic field Hs and the magnetic field Hs′ observed where the tangential line of the hysteresis loop of the coercive force Hc intersects with the magnetization saturation portion (the portion existing parallel to the abscissa axis in the hysteresis loop). Normally, the S-N properties are better when ΔHs is smaller.

First, the thicknesses of the exchange coupling control layers that can achieve a certain coercive force and a certain recording inverted magnetic field in the magnetic disk 10 of this embodiment and the conventional ECC medium 20 are described, with reference to FIGS. 4A and 4B. To achieve 4800 (Oe) in the coercive force Hc and 8500 (Oe) in the recording inverted magnetic force Hs, for example, the layer thicknesses of the exchange coupling control layers 10e and 10g of the magnetic disk 10 need to be approximately 0.28 nm (see the points A and A′ in FIGS. 4A and 4B). In the conventional ECC medium 20, on the other hand, the layer thickness of the exchange coupling control layer 20e needs to be approximately 0.35 nm (see the points B and B′ in FIGS. 4A and 4B).

Next, the parameters ΔHs representing the variations of the recording inverted magnetic fields in the case where the layer thicknesses of the respective exchange coupling control layers are set as above are described. In this case, ΔHs is approximately 820 (Oe) in the ECC medium 20 (see the point B″ in FIG. 4C), and is approximately 780 (Oe) in the magnetic disk 10 (see the point A″ in FIG. 4C).

As described above, ΔHs in the magnetic disk 10 of this embodiment can be set smaller than ΔHs in the conventional ECC medium 20. Accordingly, the S-N properties in the magnetic disk 10 are preferable to the S-N properties in the ECC medium 20. This implies that the magnetic disk 10 has higher recording reproduction resolution performance than the conventional ECC medium 20.

As described so far, in accordance with this embodiment, the layer stack portion 110 stacked on the substrate 10a includes the three magnetic recording layers 10d, 10f, and 10h, and the two exchange coupling control layers 10e and 10g inserted into the respective spaces between the three magnetic recording layers 10d, 10f and 10h. As the number of exchange coupling control layers is greater than in conventional cases, it is possible to reduce the layer thickness of each exchange coupling control layer required to achieve a smaller coercive force and smaller recording inverted magnetic field than certain amounts. Also, the coupling force between the magnetic recording layers via an exchange coupling control layer can be suitably controlled by reducing the layer thicknesses of the respective exchange coupling control layers 10e and 10g. Accordingly, the variation ΔHs of the recording inverted magnetic field can be reduced. In this manner, excellent S-N properties can be achieved. Furthermore, the inverted magnetic field reducing effect can be certainly expected from the entire medium having the two exchange coupling control layers. Thus, excellent magnetic recording properties and high reproduction resolution performance can be achieved.

Also, in accordance with this embodiment, the magnetic disk 10 has excellent magnetic recording properties and high reproduction resolution performance. Thus, high-density recording can be performed on the magnetic disk 10.

Although two exchange coupling control layers are provided in the above embodiment, it is possible to prepare three or more exchange coupling control layers in the present invention. In such a case where three or more exchange coupling control layers are provided, it might be possible to further reduce the layer thickness of each of the exchange coupling control layers. However, the layer thickness suitable for mass production and the costs of the manufacturing devices should be taken into consideration, when the optimum number of exchange coupling control layers is determined.

Although the magnetic disk 10 of this embodiment has the structure depicted in FIG. 2, various modifications may be made to the structure within the scope of the invention. For example, various other structures may be employed for the layers other than the magnetic recording layers and the exchange coupling control layers. Also, the components and compositions of the respective layers are not limited to the examples described in the above embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various change, substitutions, and alterations could be made hereto without departing from the spirit and scope of the invention.

What is claimed is:

1. A magnetic recording medium comprising:
a substrate; and
a layer stack unit that includes n (n being 3 or an integer greater than 3) magnetic recording layers, and (n−1) exchange coupling control layers placed in respective spaces between the n magnetic recording layers, the n magnetic recording layers and the (n−1) exchange coupling control layers being stacked on the substrate.

2. The magnetic recording medium as claimed in claim 1, wherein the exchange coupling control layers are two exchange coupling control layers.

3. The magnetic recording medium as claimed in claim 1, wherein the layer stack unit includes another magnetic recording layer that is stacked on the magnetic recording layer that is the farthest from the substrate among the n magnetic recording layers.

4. The magnetic recording medium as claimed in claim 1, wherein:
a material for the n magnetic recording layers is a granular material containing a CoCrPt alloy and an oxide; and
a material for the another magnetic recording layer is an alloy material containing CoCrPt.

5. The magnetic recording medium as claimed in claim 1, wherein a Pt composition amount of each of the magnetic recording layers is smaller as a distance from the substrate is longer.

6. The magnetic recording medium as claimed in claim 1, wherein a material for the exchange coupling control layers is Ru or a material containing Ru.

7. A magnetic recording apparatus comprising
the magnetic recording medium as claimed in claim 1, the magnetic recording medium serving as a magnetic recording medium for perpendicular magnetic recording.
